(19) United States
(12) Patent Application Publication
(10) Pub. No.: US 2013/0068260 A1
(43) Pub. Date: Mar. 21, 2013

(54) METHOD OF CLEANING ELECTRONIC MATERIAL AND CLEANING SYSTEM

(71) Applicants: Haruyoshi Yamakawa, Shinjuku-ku (JP); Hiroto Tokoshima, Shinjuku-ku (JP)

(72) Inventors: Haruyoshi Yamakawa, Shinjuku-ku (JP); Hiroto Tokoshima, Shinjuku-ku (JP)

(73) Assignee: KURITA WATER INDUSTRIES LTD, Tokyo (JP)

(21) Appl. No.: 13/634,567

(22) PCT Filed: Mar. 2, 2011
(86) PCT No.: PCT/JP2011/054739

§ 371 Date: Nov. 30, 2012

(30) Foreign Application Priority Data
Mar. 15, 2010 (JP) 2010-057246

(51) Int. Cl. B08B 3/04

(52) U.S. Cl. CPC B08B 3/04
USPC 134/26; 134/95.3

(57) ABSTRACT

An electronic material cleaning system includes a chemical cleaning means, a wet cleaning means and a single-wafer cleaning apparatus. The chemical cleaning means comprises a functional chemical storage tank and an electrolytic reaction apparatus connected to the functional chemical storage tank via a concentrated sulfuric acid electrolysis line. The functional chemical storage tank can supply a functional chemical to the single-wafer cleaning apparatus via a functional chemical supply line. The wet cleaning means comprises a pure water supply line, a nitrogen gas supply line connected to a nitrogen gas source and an internal mixing type two-fluid nozzle connected respectively to the pure water supply line and the nitrogen gas supply line. Droplets generated from a nitrogen gas and ultrapure water can be sprayed from the tip of the two-fluid nozzle.

### TECHNICAL FIELD

The present invention relates to a cleaning method and a cleaning system for effectively stripping and removing a resist, etc. on an electronic material in an electronic device manufacture field, wherein extremely strict control is required, specifically, in the manufacture field of semiconductor substrates, liquid crystal displays and organic EL displays, and photomasks, etc. thereof.

### BACKGROUND ART

A manufacture process of semiconductors comprises a step of partially implanting metal ion as an impurity on a surface of a semiconductor wafer. In this step, a resist made by a photosensitive resin, etc. is formed to be a pattern as a mask member for preventing implant in undesired parts and ion having an equal concentration is also implanted on the resist surface. The resist subjected to ion implantation is an unnecessary product in manufacturing, so that a resist removal treatment for stripping and removing it from the wafer surface is performed.

In a resist removal treatment as such, after ashing the resist in an ashing apparatus, the result is fed to a cleaning apparatus, where a resist residue is removed by using a cleaning liquid. However, there is a problem that a part not protected by the resist is damaged when performing an ashing treatment in an ashing apparatus. As a countermeasure to this problem, the patent document 1 describes supplying SPM, which is a mixed liquid of sulfuric acid and hydrogen peroxide, to the wafer surface and unnecessary resist on the wafer surface is stripped and removed by using an oxidation power of peroxomonosulfuric acid (H₂SO₅) contained in the SPM.

Even in the case of cleaning with SPM, when an ion implantation amount is at a high concentration, a surface of a resist is sometimes modified and cannot be removed well or it takes time to remove the resist. Therefore, for such a case, the patent document 1 proposes a method of providing a single-wafer cleaning apparatus with an SPM supply nozzle and two-fluid nozzle for jet flowing droplets, supplying droplet jet, then, supplying high-temperature SPM to sprit and remove a resist from a wafer.

However, in a resist stripping treatment by using SPM, since an oxidation power is maintained by mixing sulfuric acid and hydrogen peroxide water when cleaning, the oxidation power of the chemical declines after use. Accordingly, in the case of using SPM in a resist removal step using a single-wafer cleaning apparatus, if the chemical is circulated for reuse, the cleaning power becomes unstable and, moreover, a large amount of sulfuric acid and hydrogen peroxide water are consumed, so that the running cost becomes high and a large amount of waste water arises, which are disadvantageous.

On the other hand, the present inventors propose a cleaning method and a cleaning system wherein, instead of the SPM cleaning solution, an electrolytic sulfuric acid solution containing oxidizing substances, such as peroxomonosulfuric acid obtained by electrolyzing sulfuric acid, is used as a cleaning solution and sulfuric acid is circulated for use (for example, patent documents 2 and 3). In this method, the oxidation power can be maintained easily at a certain level or higher, and a drastic reduction in an amount of chemical can be expected because the chemical is scarcely added or replaced. Also, since a cleaning solution with a high oxidation power can be produced continuously, it is expected to realize stripping and cleaning without an asking treatment (ashing-free cleaning).

### PRIOR ART DOCUMENTS

### [Patent Documents]

[Patent Document 1] Japanese Patent Publication (Kokai) No. 2005-109167
[Patent Document 2] Japanese Patent Publication (Kokai) No. 2006-114880
[Patent Document 3] Japanese Patent Publication (Kokai) No. 2006-278687

### SUMMARY OF THE INVENTION

In the resist stripping treatment method with SPM described in the patent document 1, as the manufacture process becomes complicated, it is liable that the time required for manufacture becomes longer, therefore, there are demands for reducing time required for each step including the resist stripping step. Also, in the case of performing ashing-free resist stripping and cleaning by using a sulfuric acid solution containing persulfate obtained by electrolyzing a sulfuric acid solution, not-stripped resist residues are liable to remain on an electronic material, consequently, it is desired that the residues are removed without fail in a short time in later wet cleaning.

Here, the cleaning methods proposed in the patent documents 2 and 3 may be applied. This cleaning method allows a reduction of amounts of chemical and waste fluid and also a high cleaning effect can be obtained thereby. Also, the cleaning method described in the patent document 3 can be also applied to a single-wafer cleaning. However, the cleaning methods described in these patent documents have a room for improvement in terms of time until when an unnecessary resist to be removed completely from a silicon wafer.

The present invention was made in consideration of the above problems and has an object thereof to provide a cleaning method and a cleaning system of electronic materials, with which time for a resist stripping treatment of electronic materials can be reduced and, furthermore, resist residues can be removed without fail in a short time by wet cleaning after resist stripping.

To solve the above problems, firstly, the present invention provides an electronic material cleaning method, comprising a chemical cleaning step for bringing a functional chemical obtained by electrolyzing sulfuric acid into contact with an electronic material, and a wet cleaning step for bringing a jet flow of droplets generated from a gas and a liquid into contact with the electronic material (Invention 1).

According to the invention above (Invention 1), since the wet cleaning step for bringing into contact with a jet flow of droplets generated from a gas and a liquid exhibits a high cleaning power, time for subsequent rinse cleaning can be reduced or omitted. As a result of providing a wet cleaning step as such after the cleaning step using functional chemical with an excellent resist stripping capability, time required for cleaning can be drastically reduced compared with that in the methods of the related art.

In the invention above (Invention 1), preferably, the functional chemical brought into contact with the electronic material is collected, electrolyzed again and reused (Invention 2).

According to the invention above (Invention 2), as a result of repeatedly using the functional chemical, an amount of the chemical to be used and wasted can be drastically reduced, cleaning time of a subject material for cleaning can be reduced, and throughput can be improved.

In the inventions above (Inventions 1 and 2), preferably, the functional chemical in a state of being heated to 100 to 200° C. is brought to contact with the electronic material (Invention 3).

According to the invention above (Invention 3), persulfate contained in the functional chemical can behave effectively to exhibit a sufficient cleaning effect, boiling of the functional chemical can be prevented and, furthermore, it is possible to prevent members composing the apparatuses from exceeding a normal temperature limit.

In the inventions above (Inventions 1 to 3), preferably, a sulfuric acid concentration in the functional chemical is 80 to 96 wt % (Invention 4).

According to the invention above (Invention 4), a sufficient cleaning effect can be brought out by the functional chemical obtained by electrolyzing sulfuric acid.

In the inventions above (Inventions 1 to 4), preferably, at least an anode of electrodes used for electrolyzing the sulfuric acid is a conductive diamond electrode, and the functional chemical contains persulfate generated by an oxidation reaction at the anode.

According to the invention above (Invention 5), as a result of using a conductive diamond electrode as the anode, persulfate having a high cleaning capability can be produced effectively and electrode durability can be improved, as well.

In the inventions above (Inventions 1 to 5), preferably, the jet flow of droplets generated from a gas and a liquid is generated from pure water and one kind of gas or a mixed gas of two or more kinds selected from nitrogen, oxygen, noble gas, cleaned air, carbon dioxide and ozone (Invention 6).

According to the invention above (Invention 6), the wet cleaning can be efficiently performed in a short time without causing any adverse effect on an electronic material.

In the inventions above (Inventions 1 to 6), preferably, the electronic material is subjected to single-wafer cleaning in a state of being fixed to a rotation device (Invention 7).

According to the invention above (Invention 7), it is possible to efficiently perform spin cleaning of pouring functional chemical and spraying a jet flow of droplets to the electronic material surface for each piece while rotating the electronic material.

Secondly, the present invention provides an electronic material cleaning system, comprising a chemical cleaning means for bringing a functional chemical obtained by electrolyzing sulfuric acid into contact with an electronic material, and a wet cleaning means for bringing a jet flow of droplets generated from a gas and a liquid into contact with the electronic material (Invention 8).

According to the invention above (Invention 8), since the wet cleaning means for bringing into contact with a jet flow of droplets generated from a gas and a liquid exhibits a high cleaning power, subsequent rinse cleaning time can be reduced or omitted. As a result of providing a wet cleaning means as such and a cleaning means with a functional chemical having an excellent resist stripping capability, time required for cleaning can be drastically reduced compared with that in the methods of the related art.

In the invention above (Invention 8), preferably, a collecting means for collecting the functional chemical brought to contact with the electronic material is provided (Invention 9).

According to the invention above (Invention 9), after cleaning an electronic material with a functional chemical in the chemical cleaning means, the functional chemical is collected by the collecting means, electrolyzed again in the electrolytic reaction apparatus and used repeatedly, so that an amount of the chemical to be used and wasted can be drastically reduced, treatment time of a cleaning subject can be reduced and throughput can be improved.

In the inventions above (Inventions 8 and 9), preferably, a heating device for heating the functional chemical is provided (Invention 10).

According to the invention above (Invention 10), persulfate contained in the functional chemical can behave efficiently to exhibit a sufficient cleaning effect, boiling of the functional chemical can be prevented, furthermore, it is possible to heat the members composing the apparatuses to a temperature to prevent exceeding a normal temperature limit thereof, and cleaning can be performed efficiently.

In the inventions above (Inventions 8 to 10), preferably, the chemical cleaning means comprises an electrolytic reaction apparatus for producing a persulfuric acid-containing sulfuric acid solution by electrolyzing a sulfuric acid solution.

According to the invention above (Invention 11), sulfuric acid is electrolyzed in the electrolytic reaction apparatus to produce a persulfuric acid-containing sulfuric acid solution suitable for cleaning, and a sufficient cleaning effect can be brought out.

In the inventions above (Inventions 8 to 11), preferably, at least an anode of electrodes of the electrolytic reaction apparatus is a conductive diamond electrode (Invention 12).

According to the invention above (Invention 12), as a result of using a conductive diamond electrode as the anode, persulfate having a high cleaning capability can be produced effectively, and electrode durability can be improved, as well.

In the inventions above (Inventions 8 to 12), preferably, the wet cleaning means comprises a two-fluid nozzle having a pure water supply line and an inert gas supply line (Invention 13).

According to the invention above (Invention 13), droplets generated from a gas and a liquid can be efficiently ejected, and the wet cleaning can be performed efficiently without causing any adverse effect on an electronic material.

In the inventions above (Inventions 8 to 13), preferably, a rotation device to which the electronic material can be fixed is provided (Invention 14).

According to the invention above (Invention 14), it is possible to efficiently perform spin cleaning of pouring functional chemical and spraying a jet flow of droplets to the electronic material surface for each piece while rotating the electronic material.

According to the electronic material cleaning method of the present invention, since the wet cleaning step for bringing into contact with a jet flow of droplets generated from a gas and liquid has a higher cleaning power compared with APM and HPM used conventionally in wet cleaning, it is possible to reduce time for subsequent rinse cleaning or the rinse cleaning may be omitted. As a result of providing the wet cleaning step as such after the cleaning step with functional chemical having an excellent capability of stripping a resist, the time required for cleaning can be reduced drastically compared with that in the methods of the related art.

### BRIEF DESCRIPTION OF DRAWINGS

FIG. 1A flowchart showing an electronic material cleaning system according to an embodiment of the present invention.

### MODE FOR CARRYING OUT THE INVENTION

Below, an explanation will be made on an embodiment of the present invention with reference to the drawings.

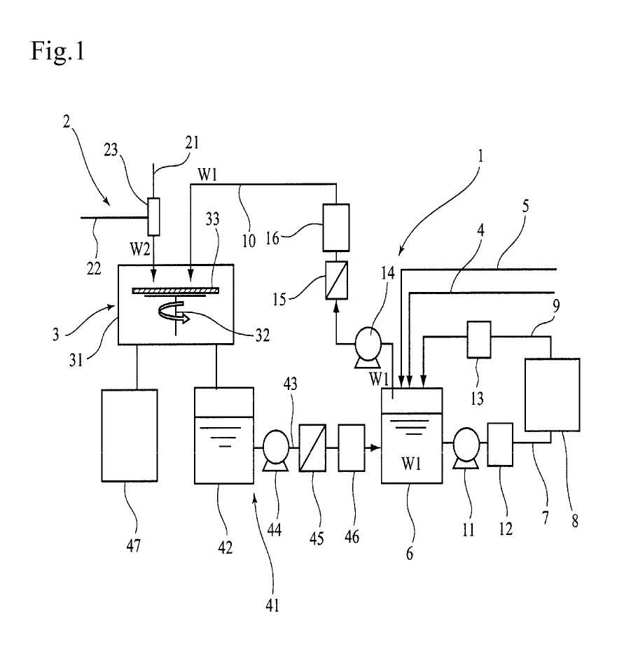

FIG. 1 is a flowchart showing an electronic material cleaning system according to an embodiment of the present invention.

In FIG. 1, the electronic material cleaning system comprises a chemical cleaning means 1, a wet cleaning means 2 and a single-wafer cleaning apparatus 3. The chemical cleaning means 1 comprises a functional chemical storage tank 6, which is connected to a concentrated sulfuric acid supply line 4 further connected to a not shown concentrated sulfuric acid tank and to a pure water supply line 5 further connected to a not shown ultrapure water producing apparatus, and an electrolytic reaction apparatus 8, which is connected to the functional chemical storage tank 6 via a concentrated sulfuric acid electrolysis line 7. The electrolytic reaction apparatus 8 is connected to the functional chemical storage tank 6 via the concentrated sulfuric acid electrolysis line 7 so as to form a circulation line. The functional chemical storage tank 6 can supply functional chemical W1 to the single-wafer cleaning apparatus 3 via the functional chemical supply line 10. Note that the persulfate electrolysis line 7 is provided with a liquid feed pump 11 and a cooling device 12, the persulfate supply line 9 is provided with a gas-liquid separator 13, and the functional chemical supply line 10 is provided with a chemical supply pump 14, a filter 15 and a heating device 16 as a heating means, respectively. With this heating device 16, the functional chemical W1 can be controlled to be a later-explained predetermined temperature by a not shown control mechanism thereof.

Also, the wet cleaning means 2 comprises a supply line 21 of pure water as a liquid connected to a not shown ultrapure water producing apparatus, a nitrogen gas supply line 22 connected to a nitrogen gas source (not shown) as a gas, and an internal mixing type two-fluid nozzle 23 respectively connected to the pure water supply line 21 and the nitrogen gas supply line 22. Droplets W2 generated from a nitrogen gas and ultrapure water can be sprayed from the tip of the two-fluid nozzle 23.

The single-wafer cleaning apparatus 3 comprises a cleaning case 31 and a rotation device 32 provided to the cleaning case 31. A silicon wafer 33, an electronic material, as a cleaning subject can be fixed to the rotation device 32.

The single-wafer cleaning apparatus 3 is provided with a collecting means 41. The collecting means 41 is configured by a sulfuric acid waste tank 42 and a sulfuric acid waste supply line 43, wherein the sulfuric acid waste supply line 43 is provided with a liquid feeding pump 44, a filter 45 and a cooling device 46. Furthermore, the single-wafer cleaning apparatus 3 is provided with a pure water line waste tank 47.

In the cleaning system configured as above, electrolysis is performed by an anode and a cathode in pair in the electrolytic reaction apparatus 8. A material of the electrodes is not particularly limited, but when using platinum as an anode, which has been generally and widely used as electrodes, there are problems that persulfate cannot be produced efficiently and the platinum eludes. In the present embodiment, a conductive diamond electrode is used at least as an anode. It has been known to use conductive diamond electrodes and to generate peroxodisulfate ion from sulfate ion or hydrogensulfate ion under the condition of a current density being 0.2 A/cm² or so (Ch. Comninellis et al., Electrochemical and Solid-State Letters, Vol. 3, No. 2, pp 77-79, 2000).

The conductive diamond electrode includes those obtained by using a silicon wafer or other semiconductor material as a substrate and synthesizing a conductive diamond thin film in 20 μm or more on the substrate surface and self-standing type conductive polycrystalline diamond obtained by depositing in a plate shape without a substrate. Note that the conductive diamond thin film is obtained by doping boron or nitrogen when synthesizing a diamond thin film so as to give conductivity, and normally those doped with boron is common. When an amount of doping is too small, the technical significance does not arise, while when too large, the effect of doping saturates, so that those within a range of 50 to 20000 ppm with respect to a carbon content in the diamond thin film are suitable. In the present embodiment, a plate-shaped conductive diamond electrode is normally used but a mesh structure formed into a plate shape may be used, as well. In an electrolysis treatment in the electrolytic reaction apparatus 8, preferably, a current density on the conductive diamond electrode surface is 10 to 100000 A/m² and a treatment of contacting with concentrated sulfuric acid is preferably performed in parallel with the diamond electrode surface at the liquid feeding linear speed of 10 to 10000 m/h.

As a silicon wafer 33 as a cleaning subject, electronic materials formed with a resist pattern in a manufacturing process of, for example, semiconductor substrates, liquid crystal displays, organic EL displays and photomasks, etc. thereof may be used. Normally, a thickness of a resist film on the electronic material is 0.1 to 2.0 μm or so, however, it is not limited to this.

Effects of the cleaning system configured as above will be explained. First, concentrated sulfuric acid is supplied from the concentrated sulfuric acid supply line 4 to the functional chemical storage tank 6 and pure water is supplied from the pure water supply line 5 so as to adjust a concentration of the sulfuric acid. At this time, a concentration of the sulfuric acid in the functional chemical storage tank 6 is preferably adjusted to be 80 to 96 wt %.

When the functional chemical storage tank 6 is filled with the concentrated sulfuric acid in a predetermined amount, the liquid feeding pump 11 is activated to supply the concentrated sulfuric acid to the electrolytic reaction apparatus 8. At this time, if the electrolysis temperature is exceedingly high, the electrolysis efficiency declines and wear damage on the electrodes becomes large. However, if the electrolysis temperature is exceedingly lowered, heating energy becomes large at the time of using it in the later explained chemical cleaning step. Therefore, it is preferable to cool the concentrated sulfuric acid to 10 to 90° C., particularly, 40 to 80° C. by the cooling device 12. As a result of electrolyzing sulfuric acid in the electrolytic reaction apparatus 8, persulfate is generated.

The persulfate to be generated in the present embodiment is peroxomonosulfuric acid (H₂SO₅) and peroxodisulfuric acid (H₂S₂O₈). Both of the peroxomonosulfuric acid and peroxodisulfuric acid have a high oxidation power.

Persulfate generated as above is fed back from the persulfate supply line 9 to the functional chemical storage tank 6. By repeating this, the functional chemical W1 composed of persulfate and surfuric acid is stored in the functional chemical storage tank 6 and when the sulfuric acid concentration becomes 80 to 96 wt % (a persulfate concentration of 2 to 20 [g/L (as S₂O₈)], the chemical supply pump 14 is activated, so that the functional chemical W1 is supplied from the functional chemical supply line 10 to the single-wafer cleaning apparatus 3. When the persulfate concentration is less than 2 [g/L (as S₂O₈)], the oxidation power is insufficient and a sufficient cleaning effect, such as a resist stripping effect, of the silicon wafer 33 cannot be obtained, while when exceeding 20 [g/L (as S₂O₈)], it is ineffective in terms of current efficiency.

At this time, if the temperature of the functional chemical W1 is too low, sufficient cleaning effect cannot be obtained, while when too high, a sulfuric acid solution comes to a boil depending on the sulfuric acid concentration, etc. Therefore, it is preferably heated to 100 to 200° C., particularly, 100 to 180° C. by the heating device 16.

Then, the silicon wafer 33 fixed to the rotation device 32 of the single-wafer cleaning apparatus 3 is supplied with the functional chemical W1 from the functional chemical supply line 10 while rotating the silicon wafer 33 so as to bring the functional chemical W1 contact with the silicon wafer 33, consequently, a resist, etc. on the silicon wafer 33 is stripped (the chemical cleaning step).

An amount of time for cleaning in the chemical cleaning step as explained above is not particularly limited and varies depending on a adhesion state of the resist to the silicon wafer as the cleaning subject, provision of an asking treatment or not prior to the striping and cleaning, a persulfate concentration in the functional chemical W1 and the solution temperature, and a condition of a subsequent wet cleaning step, etc. but it is normally 10 to 300 seconds and particularly preferably 15 to 120 seconds or so.

The functional chemical W1 after cleaning as above is stored in the sulfuric acid waste tank 42 of the collecting means 41, then, returns from the sulfuric acid waste supply line 43 to the functional chemical storage tank 6 by the liquid feeding pump 44. At this time, if the temperature of the sulfuric acid is exceedingly high, the electrolysis efficiency declines and wear damage on the electrodes becomes large as explained above, therefore, the sulfuric acid waste is preferably cooled by the cooling device 46 to 10 to 90° C., particularly 40 to 80° C. before returning to the functional chemical storage tank 6.

When the chemical cleaning step is completed as explained above, it proceeds to the wet cleaning step. Rinse cleaning with rinse water may be performed between the resist stripping and cleaning step and the wet cleaning step. However, the rinse cleaning is not always necessary and it may proceed to the wet cleaning without the rinse cleaning. When performing a rinse cleaning step, ultrapure water is normally used as the rinse water. Here, ultrapure water is water having a quality that, for example, the electric specific resistance is 18 MΩ·cm or higher, a metal ion concentration is 5 ng/L or lower, a residual ion concentration is 10 ng/L or lower, a number of fine particles of 0.1 μm or larger is 5 or less in 1 mL, and TOC is 0.1 to 10 μg/L.

In the wet cleaning step, pure water is supplied from the pure water supply line 21 while a nitrogen gas is supplied from the nitrogen gas supply line 22, and the two join at the internal mixing type two-fluid nozzle 23. In the two-fluid nozzle 23, the nitrogen gas and pure water is mixed inside the nozzle. Droplets W2 generated from the nitrogen gas and ultrapure water from the two-fluid nozzle is brought to contact with the silicon wafer 33 fixed to the rotation device 32 of the single-wafer cleaning apparatus 3, thereby, the silicon wafer 33 is cleaned (the wet cleaning step).

An amount of time for cleaning in the wet cleaning step as explained above is not particularly limited and varies depending on a condition of the chemical cleaning step explained above and a condition of the wet cleaning step, etc., however, it is normally 10 to 300 seconds and particularly preferably 15 to 120 seconds or so. Also, the nitrogen gas (gas) and the pure water may be supplied at a ratio of 10 to 10000 nitrogen gas (gas) to 1 pure water in volume.

After the wet cleaning, based on the normal method, spin drying and IPA drying complete a series of the resist stripping, cleaning and removing treatment, and an electronic material finished with the resist removal is fed to the next step.

The droplets W2 after cleaning as explained above is stored in the pure water line waste tank 47 before being subjected to a predetermined treatment, then, discharged to the outside environment or reused.

By repeating operations as above continuously or intermittently, silicon wafers 33 can be treated successively. Alternatively, the operations as above may be repeated for several times for one silicon wafer 33.

The present invention was explained above based on the embodiment, however, the present invention is not limited to the embodiment explained above.

For example, in the present embodiment, an explanation was made on the case of a single-wafer cleaning, however it is also applicable to batch cleaning.

In the present embodiment, droplets generated from a gas and a liquid were generated from a nitrogen gas and pure water, however, an ozone gas, hydrogen gas, oxygen gas and other variety of gases may be used as the gas.

Furthermore, in the embodiment above, an explanation was made on the case of not performing ashing on the electronic material, however, an ashing treatment may be performed prior to the functional chemical cleaning. An ashing treatment is performed by performing an ashing treatment on a resist on the electronic material by using oxygen plasma, etc. based on the normal method. However, in the present invention, when using a persulfuric acid-containing sulfuric acid solution produced by electrolyzing a sulfuric acid solution, a resist residue problem is not caused even if the ashing treatment is omitted, and the resist can be cleaned and removed without fail. An omission of the ashing treatment allows a drastic reduction of time and cost required for the series of resist stripping treatment.

### EXAMPLES

Below, the present invention will be explained further in detail by using examples and comparative examples.

### Example 1

By using a test apparatus shown in FIG. 1, a test of stripping and removing a resist on a 12-inch wafer, on which a patterned resist for a KrF excimer laser was formed with an As ion implant concentration of 1E+15-[atoms/cm²], was conducted.

The test condition was that sulfuric acid (functional chemical W1) electrolyzed in the electrolytic reaction apparatus 8 in an amount of approximately 30 L was pooled in the functional chemical storage tank 6 while adjusting a sulfuric acid concentration to be 92 wt % and a persulfate concentration to be 10 g/L (as S₂O₈), and the functional chemical W1 was supplied by the chemical supply pump 14 to the single-wafer cleaning apparatus 3 while heating it by the heating device 16. The heating device 16 heated the functional chemical W1 to 180° C., and the functional chemical W1 at 160 to 170° C. was supplied to the silicon wafer 33 fixed inside the single-wafer cleaning apparatus 3, where the chemical cleaning step was performed. The chemical cleaning step was performed with a supply amount of the functional chemical W1 to the silicon wafer 33 at approximately 1 L/minute and the supply of the functional chemical continued for two minutes. Subsequently, cleaning with a jet flow of droplets W2 generated by the two-fluid nozzle 23 supplied with pure water in a flow amount of 100 mL/minute and a N₂ gas in a flow amount of 50 L/minute was performed for 60 seconds as the wet cleaning step. After that, spin drying was performed and the resist stripping treatment was completed. It took 4 minutes from the start of supplying the functional chemical W1 till the completion of the resist stripping treatment including the spin drying.

### Example 2

Other than changing an amount of time for the chemical cleaning step to 30 seconds and time for the wet cleaning step to 30 seconds and repeating them for two times before the spin drying, a resist stripping treatment was performed in the same way as in the example 1. The result was that it took 4 minutes from the start of supplying the functional chemical W1 till completion of the resist stripping treatment including the spin drying.

### Comparative Example 1

Other than changing the wet cleaning step for 1 minute with pure water in an amount of 2 L/minute before the spin drying, a resist stripping treatment was performed in the same way as in the example 1. The result was that many resist residues remained adhering on the silicon wafer 33 and the resist stripping treatment was not completed. Then, the yet-to-be completed silicon wafer 33 with the resist residues was subjected to cleaning with the functional chemical W1 for 2 minutes and a treatment with pure water in an amount of 2 L/minute for 1 minute, however, it was confirmed visually that the resist residues were not removed completely. From the result, it was understood that resist was hard to be stripped by performing the wet cleaning step only with pure water even if an amount of the functional chemical W1 or the cleaning time was doubled in the chemical cleaning step.

### Comparative Example 2

Other than changing an amount of time for chemical cleaning step to 10 minutes and the wet cleaning step to 1 minute with pure water in an amount of 2 L/minute before spin drying, a resist stripping treatment was performed in the same way as in the example 1. The result was that many resist residues remained adhering on the silicon wafer 33 and the resist stripping treatment was not completed. Then, an amount of time for the chemical cleaning step was increased sequentially until no resist residue remained, it was confirmed that 15 minutes were required for the chemical cleaning step. From the result, in the case of performing the wet cleaning step only with pure water, the cleaning time had to be very long in the chemical cleaning step and the cleaning efficiency was not favorable.

### EXPLANATION OF REFERENCE NUMBERS

1 . . . chemical cleaning means
2 . . . wet cleaning means
3 . . . single-wafer cleaning apparatus
6 . . . functional chemical storage tank (chemical cleaning means)
8 . . . electrolytic reaction apparatus (chemical cleaning means)
10 . . . functional chemical supply line (chemical cleaning means)
14 . . . chemical supply pump (chemical cleaning means)
16 . . . heating device (heating means: chemical cleaning means)
21 . . . pure water supply line (wet cleaning means)
22 . . . nitrogen gas supply line (wet cleaning means)
23 . . . two-fluid nozzle (wet cleaning means)
33 . . . silicon wafer (electronic material)
41 . . . collecting means
42 . . . sulfuric acid waste tank (collecting means)
43 . . . sulfuric acid waste supply line (collecting means)
W1 . . . functional chemical
W2 . . . droplets generated from a nitrogen gas and ultrapure water (droplets generated from a gas and liquid)

1. An electronic material cleaning method, comprising:
a chemical cleaning step for bringing a functional chemical obtained by electrolyzing sulfuric acid into contact with an electronic material; and
a wet cleaning step for bringing a jet flow of droplets generated from a gas and a liquid into contact with the electronic material.

2. The electronic material cleaning method according to claim 1, wherein the functional chemical brought to contact with the electronic material is collected, electrolyzed again and reused.

3. The electronic material cleaning method according to claim 1, wherein the functional chemical in a state of being heated to 100 to 200° C. is brought to contact with the electronic material.

4. The electronic material cleaning method according to claim 1, wherein a sulfuric acid concentration in the functional chemical is 80 to 96 wt %.

5. The electronic material cleaning method according to claim 1, wherein:
at least an anode of electrodes used for electrolyzing the sulfuric acid is a conductive diamond electrode; and
the functional chemical contains persulfate generated by an oxidation reaction at the anode.

6. The electronic material cleaning method according to claim 1, wherein the jet flow of droplets generated from a gas and a liquid is generated from pure water and one kind of gas or a mixed gas of two or more kinds selected from nitrogen, oxygen, noble gas, cleaned air, carbon dioxide and ozone.

7. The electronic material cleaning method according to claim 1, wherein the electronic material is subjected to single-wafer cleaning in a state of being fixed to a rotation device.

8. An electronic material cleaning system, comprising:
a chemical cleaning means for bringing a functional chemical obtained by electrolyzing sulfuric acid into contact with an electronic material; and
a wet cleaning means for bringing a jet flow of droplets generated from a gas and a liquid into contact with the electronic material.

9. The electronic material cleaning system according to claim 8, comprising a collecting means for collecting the functional chemical brought to contact with the electronic material.

10. The electronic material cleaning system according to claim 8, comprising a heating device for heating the functional chemical.

11. The electronic material cleaning system according to claim 8, wherein the chemical cleaning means comprises an electrolytic reaction apparatus for producing a persulfuric acid-containing sulfuric acid solution by electrolyzing a sulfuric acid solution.

12. The electronic material cleaning system according to claim 8, wherein at least an anode of electrodes of the electrolytic reaction apparatus is a conductive diamond electrode.

13. The electronic material cleaning system according to claim 8, wherein the wet cleaning means comprises a two-fluid nozzle having a pure water supply line and an inert gas supply line.

14. The electronic material cleaning system according to claim 8, comprising a rotation device to which the electronic material can be fixed.

15. The electronic material cleaning method according to claim 2, wherein the functional chemical in a state of being heated to 100 to 200° C. is brought to contact with the electronic material.

16. The electronic material cleaning method according to claim 2, wherein a sulfuric acid concentration in the functional chemical is 80 to 96 wt %.

17. The electronic material cleaning method according to claim 2, wherein:
at least an anode of electrodes used for electrolyzing the sulfuric acid is a conductive diamond electrode; and
the functional chemical contains persulfate generated by an oxidation reaction at the anode.

18. The electronic material cleaning method according to claim 2, wherein the jet flow of droplets generated from a gas and a liquid is generated from pure water and one kind of gas or a mixed gas of two or more kinds selected from nitrogen, oxygen, noble gas, cleaned air, carbon dioxide and ozone.

19. The electronic material cleaning method according to claim 2, wherein the electronic material is subjected to single-wafer cleaning in a state of being fixed to a rotation device.

20. The electronic material cleaning method according to claim 3, wherein a sulfuric acid concentration in the functional chemical is 80 to 96 wt %.
